(19) United States
(12) Patent Application Publication
(10) Pub. No.: US 2006/0141265 A1
(43) Pub. Date: Jun. 29, 2006

(54) Solar control coated glass composition with reduced haze

(76) Inventors: David A. Russo, Lower Providence, PA (US); Jeffery Lee Stricker, Lower Merion Township, PA (US); Laurie Alan Welborn, North Wales Borough (GB)

Correspondence Address: ARKEMA INC.;PATENT DEPARTMENT - 26TH FLOOR, 2000 MARKET STREET, PHILADELPHIA, PA, 19103-3222, US

(21) Appl. No.: 11/023,945

(22) Filed: Dec. 28, 2004

(51) Int. Cl. B32B 17/06; B32B 19/00; B05D 5/06; B05D 1/36

(52) U.S. Cl. 428/426; 428/432; 428/702; 427/164; 427/402

(57) ABSTRACT

A solar-control transparent substrate composition is presented having a transparent substrate, a multi-layer stack and a low emissivity layer thereon. The multi-layer stack comprises at least three sub-layers with at least one sub-layer being a near infrared solar absorbing layer and at least one sub-layer being a low refractive index layer. Also provided is a method of producing the improved, coated, solar-controlled transparent substrate. The solar-control transparent substrate composition provides an improved solar control glass with reduced haze, improved visible transmission and a more neutral reflective color.

### FIELD OF THE INVENTION

This invention relates to a solar control coated transparent substrate having solar control, low emissivity and low haze properties. The coated article comprises a transparent substrate, a multi-layer stack of at least three sub-layers thereon and a low emissivity metal oxide layer on the multi-layer stack. The multi-layer stack has at least one near infrared absorbing sub-layer and at least one low refractive index sub-layer. The near infrared absorbing sub-layer or sub-layers have a relatively high refractive index and comprise a near infrared absorbing material. The low refractive index sub-layer or sub-layers have a relatively low refractive index in comparison to the near infrared layer(s). The multi-layer stack can comprise alternating or non-alternating near infrared absorbing/low refractive index sub-layers. This construction results in a coating having reduced haze, improved visible light transmission and a more neutral reflective color.

### BACKGROUND OF THE INVENTION

A variety of pyrolytic solar control, low emissivity coatings are known. In general, these combine a solar absorbing layer with an infrared reflective (low emissivity or Low E) layer.

Solar-control is a term describing the property of regulating the amount of solar heat energy that is allowed to pass through a window into an enclosed space such as a building or an automobile interior. Low emissivity (sometimes referred to as Low E) is a term describing the property of an article's surface wherein mid-range infrared radiation is reflected, thereby reducing heat flux through the article. By suppressing solar heat gain, building and automobile interiors are kept cooler; allowing a reduction in air conditioning requirements and costs. Windows incorporating low emissivity coatings improve building energy efficiency and comfort during both summer and winter as a result of increased thermal insulating performance. By combining solar control and low emissivity into the same article, absorbed solar heat is reradiated preferentially towards the exterior, providing improved solar heat gain reduction.

The demand for high-performance solar control glazing is growing rapidly. Important attributes for commercial acceptance are, energy performance, manufacturing economics, neutral color, low haze, product durability and extended shelf life.

Haze in pyrolytic coatings can be due to large crystallite size, a wide range of crystallite sizes and/or particulates imbedded in the film surface. It can also be caused by voids (holes) in the film due to the volatilization of intermediate by-products such as NaCl. Traditionally, voids have been eliminated by careful control of process conditions and/or a selective choice of precursors. Another method utilized is to first deposit a thin (60 to 100 nm) barrier layer of metal oxide in an amorphous or semi-crystalline state to block migrating sodium ions from the glass from combining with halogen by-products from the precursor. Other methods include the addition of adjuvant materials to the deposition vapors of the first functional coating layer. Haze due to surface roughness has been removed by polishing the films but this off-line process is uneconomical. Other methods include the addition of separate “breaker” layers between the functional layers or the addition of top layers that smooth the rugose surface. These additional layers complicate the deposition process.

As explained below, various technologies have been employed to incorporate the features of solar-control and low emissivity in the same glass article. However, no one system has successfully met all of the performance requirements in an economic manner.

The deposition of thin transparent coatings onto a transparent substrate having a different refractive index than that of the coating generally results in interference colors (iridescence) which are visible in reflectance. Iridescence is objectionable in most glazing applications. Such iridescence can, in some cases, be minimized or eliminated by placing an anti-iridescence layer between the glass substrate and the first coating. The use of an interference layer between the glass and a subsequent functional layer or layers to suppress iridescence or color reflection was first demonstrated by Roy G. Gordon, and was the subject of U. S. Pat. No. 4,187,336, issued Feb. 5, 1980. The Gordon technology has been the state of the art for coated solar control glass as evidenced by recently issued U.S. Pat. No. 5,780,149 (McCurdy el al, Jul. 14, 1998) which applied two layers to obtain solar control on top of a Gordon type interference layer. The interference layer frequently contains silicon dioxide.

Mochel (U.S. Pat. No. 2,564,708) discloses infrared reflective coatings on glass,

including antimony-doped tin oxide. These coatings are produced by spray pyrolysis.

Johnson (U.S. Pat. No. 3,149,989) first combines a solar absorbing layer with a low emissivity layer to produce radiation-reflecting (solar control) glass. At least two coatings are used with the first coating, adhered to the glass substrate, being comprised of tin oxide doped with a relatively high level of antimony (a solar absorbing layer). The second coating is also comprised of tin oxide doped with a relatively low level of antimony (an infrared reflecting layer). The two films may be superimposed, one on another, or may be applied to opposite sides of the glass substrate. The contemplated application is solar control window glazing.

Dates et al. (U.S. Pat. No. 3,331,702) teach the chemical vapor deposition method of forming an antimony-doped tin oxide coating on glass. Dates (U.S. Pat. No. 3,473,944) further describes a coated article having two layers of antimony-doped tin oxide formed either by chemical vapor deposition or by spray pyrolysis on opposites surfaces of a piece of glass. These two layers have different concentrations of antimony and tin, one layer having a relatively high level of antimony (a solar absorbing layer) and the other layer having a relatively low level of antimony (a low emissivity layer).

Fluorine-doped tin oxide is known to be superior to antimony-doped tin oxide as a low emissivity material and as a transparent conductor, and generally has replaced antimony-doped tin oxide for these purposes. For an equivalent thickness, fluorine-doped tin oxide is capable of lower emissivity and lower sheet resistance. Lytle et al. (U.S. Pat. No. 2,651,858) teach the formation of fluorine-doped tin oxide by spray pyrolysis. Gordon (U.S. Pat. No. 4,146,657) teaches the chemical vapor deposition of high-quality fluorine-doped tin oxide coatings on glass. Chemical vapor deposition is the preferred method for producing fluorine-doped tin oxide coatings commercially.

Griest (U.S. Pat. No. 4,286,009) combines an antimony-doped tin oxide solar absorbing layer with a fluorine-doped tin oxide low emissivity layer in a heat absorbing glass article designed to convert incident solar radiation into heat energy that is transferred through the glass to a working fluid for heat transfer. Accordingly, the coated glass absorbs at least 85% of the solar radiation and has a relatively low emissivity characteristic of less than 0.2. Also consistent with its function as a solar collector, the coating is on the outside surface of the glass (facing the sun), while the heat transfer fluid is in contact with the inside surface of the glass. The construction of said solar collector comprising: a smooth absorber substrate in contact with a heat transfer medium; a solar radiation absorbing metal oxide deposited on the substrate. The solar radiation absorbing metal oxide is selected from the group consisting of antimony doped tin oxide; tin doped indium oxide and iron oxide; and a second coating of infrared reflecting metal oxide. The infrared reflecting metal oxide is selected from the group consisting of antimony doped tin oxide, fluorine doped tin oxide and tin doped indium oxide. No control over reflected color is taught.

Anti-iridescence (a neutral-colored specular reflectance) is generally desirable for architectural coatings. Gordon (U.S. Pat. No. 4,187,336) describes several non-iridescent glass structures suitable for producing low emissivity coatings having little or no reflected color. All of the non-iridescent structures taught comprise: a glass substrate; an iridescence suppressing layer or layers deposited between the glass substrate and the low emissivity layer; and an infrared reflective transparent semiconductor coating (fluorine-doped tin oxide is disclosed) Gordon also teaches that an amorphous, iridescence suppressing layer reduces haze.

In U.S. Pat. No. 4,377,613, Gordon describes an improved non-iridescent glass structure comprising a transparent substrate; an infrared reflective coating; and an iridescence-suppressing layer between said substrate and infrared reflective coating. The iridescence-suppressing layer consists of a first interlayer of relatively high refractive index material nearer to the substrate and a second interlayer of relatively low refractive index over the first interlayer. The combined thickness of the iridescence suppressing layers is an optical thickness of about ⅙^{th} of a 500 nm design wavelength. Tin oxide-based infrared reflective and first interlayer layers are taught. The incorporation of solar absorbing coatings into the non-iridescent structure is not contemplated. The inclusion of solar absorbing materials, such as antimony tin oxide, is not disclosed.

Russo et al. (U.S. Pat. No. 4,601,917) teach a liquid coating composition for producing high-quality, high-performance, fluorine-doped tin oxide coatings by chemical vapor deposition.

Russo et al. (U.S. Pat. No. 5,401,305) teach a method of depositing amorphous coatings comprising SnO₂ and SiO₂ and having controllable refractive index on glass by chemical vapor deposition.

McCurdy et al. (U.S. Pat. No. 5,780,149) describe solar control coated glass wherein at least three coatings layers are present, first and second transparent coatings and an iridescence suppressing layer lying between the glass substrate and the transparent layers. The invention relies upon the transparent layers having a difference in refractive indices in the near infrared region greater than the difference in indices in the visible region. This difference causes solar heat to be reflected in the near infrared region as opposed to being absorbed. Doped metal oxides, which have low emissivity properties, such as fluorine-doped tin oxide, are used as the first transparent layer. Metal oxides, such as undoped tin oxide are used as the second layer. No NIR absorbing combinations are described.

Hannotiau et al. (GB 2,302,102 A) claim a glazing panel comprising a vitreous substrate carrying a tin/antimony oxide coating layer containing tin and antimony in a Sb/Sn molar ratio of from 0.01 to 0.5, the said coating layer having been pyrolytically formed by chemical vapor deposition, whereby the so-coated substrate has a solar factor (FS) of less than 70%. An intermediate haze-reducing layer may be placed between the substrate and the tin/antimony oxide layer. The haze-reducing layer may comprise silicon oxide.

Terneu et al. (U.S. Pat. No. 6,231,971) describe a glazing panel having a solar factor of less than 70%, comprising: a sheet of glass; and at least two coating layers provided on the sheet of glass including a first and second coating layers. The first coating layer comprising tin and antimony oxides and having an Sb/Sn molar ratio ranging from 0.01 to 0.5 and being one of (A) pyrolytically formed from reactants in a gaseous phase or (B) pyrolytically spray formed. The second coating layer comprising tin oxide doped with fluorine. An intermediate layer is also described, which may be included into the above structure in a position between the glass and the first coating layer. This intermediate layer may consist essentially of silicon and oxygen. Terneu teaches that this intermediate layer is useful to reduce haze. Anti-iridescence is not a part of this invention.

Gallego et al. (U.S. Pat. No. 6,048,621) describes a high performance solar control glass comprising a glass substrate with a coating comprising a heat absorbing layer and a low emissivity layer of a metal compound, wherein the low emissivity layer of the coating overlies the heat absorbing layer, and wherein the low emissivity layer has a thickness in the range 100 nm to 600 nm and wherein the coated glass has an emissivity of less than 0.4. Since the thin film produced may result in the appearance of interference colors and iridescence, an iridescence suppressing layer or layers between the glass and the heat-absorbing layer may be used.

McKown, et al. (U.S. Pat. No. 6,218,018) teache a coated, solar control glass having preselected reflected color and having a NIR solar absorbing layer and a low emissivity layer, without the need for a Gordon type underlayer. The construction comprises glass having a SnO₂ coating containing at least two layers with one layer being a solar absorbing layer comprising SnO₂ containing a dopant selected from the group consisting of antimony, tungsten, vanadium, iron, chromium, molybdenum, niobium, cobalt, nickel and mixtures thereof and another layer being a low emissivity layer comprising SnO₂ containing a dopant selected from the group fluorine, phosphorous and mixtures thereof. Reflected color can be selected, including neutral reflected color, by the order, thickness and dopant type and level without the need for a separate iridescence suppressing layer. The constructions taught by McKown, et al. are not readily able to produce coatings, which have both neutral reflected color and visible transmittances greater than 70%.

Russo, et al. (U.S. Pat. No. 6,596,398) expand on the teachings of U.S. Pat. No. 6,218,018 including the addition of an additional layer either between the glass and the SnO₂ coating, or above the SnO₂ coating.

Ternue et al. (U.S. Pat. No. 4,900,634) disclose the production of a doped tin oxide films by the spray application of aqueous solutions of stannous chloride, ammonium bifluoride and antimony trichloride. They disclose that internal haze (that due to defects within the coating) is reduced by the incorporation of these two additives to the tin reagent. Haze due to the surface rugosity of the deposited film is removed by polishing.

Szanyi, et al. (WO 0055102) discloses the insertion of a 10-100 nm amorphous “breaker” layer between a crystalline solar control layer and a crystalline low emissivity layer to reduce or prevent epitaxial growth and thereby reduce haze.

McCurdy, et al. (U.S. Pat. No. 6,124,026) discloses the application of a barrier layer between the substrate and the tin oxide antimony film to prevent alkali ion metal migration that can result in undesirable appearance of haze. The barrier layer employed is about 20-25 nm of tin oxide.

Unfortunately, current solar control coatings are produced by stacking heat absorbing and low emissivity layers. Both of these layers are typically crystalline. The combined thicknesses of these two layers either leads to coatings having relatively high levels of haze or limited performance, for example, a relatively high emissivity.

There is a need for a solar control coating capable of having a relatively high visible transmittance, preferably about or greater than 70%, and neutral reflected color with little or no haze.

Surprisingly it has been found that by forming a multi-layer stack of near infrared absorbing and low emissivity layers having at least one of each and having at least three layers under a low emissivity layer on a transparent surface provides a solar control glass having acceptable visible transmittance with little or no haze. The construction of the present invention also provides a solar control glass with improved reflected color neutrality.

### SUMMARY OF THE INVENTION

It is an object of the invention to obtain a solar control coated glass or other transparent substrate capable of having a relatively high level of visible light transmittance and neutral reflected color.

It is a further object of the invention to provide a solar control glass having low haze and a high-energy efficiency performance.

The objectives of the invention are achieved, in accordance with the principles of a preferred embodiment of the invention, by a coated solar control transparent substrate composition having a near neutral reflected color comprising the following layers:
a) a transparent substrate;
b) a multi-layer stack comprising at least three sub-layers, said sub-layers including at least one solar near infrared absorbing sub-layer having a relatively high refractive index, and at least one sub-layer having a relatively low refractive index; and
c) a low emissivity layer on the multi-layer stack.

### BRIEF DESCRIPTION OF THE DRAWINGS

FIG. 1 depicts a cross-section of coated glass showing one possible orientation of the layers or films on a glass substrate.

### DETAILED DESCRIPTION OF THE INVENTION

The solar control coated transparent substrate composition of the present invention contains two distinct layers, in order from the substrate outward: a first layer comprising a multi-layer stack, and a second low-emissivity layer. The multi-layer stack has at least three sub-layers comprising at least one near infrared absorbing sub-layer with a high refractive index and at least one low refractive index sub-layer. The coated substrate composition is produced by depositing the layers sequentially on a heated transparent substrate. Additional optional layers may also be present in the composition.

The first layer on the transparent substrate is a multi-layer stack made up of at least three separate sub-layers. The separate sub-layers include one or more solar near infrared absorbing (NIR) layers having a relatively high refractive index and at least one or more low refractive index layers (LI). The multi-layer stack comprises three to ten sub-layers with four to eight sub-layers preferred and five to six sub-layers most preferred. The sub-layers can be alternating or non-alternating NIR/LI sub-layers, with alternating being preferred. The thickness of the individual sub-layers does not have to be equal but an equal distribution is preferred.

The NIR sub-layer(s) is (are) composed of tin oxide containing a dopant. The dopant is preferably antimony although the dopant can be any element selected from the group consisting of antimony, tungsten, vanadium, iron, chromium, molybdenum, niobium, cobalt, nickel, and mixtures thereof. The preferred NIR sub-layer(s) is tin oxide doped with antimony. The refractive index of antimony doped tin oxide can vary from about 1.72 to 2.00 depending on the antimony concentration. Antimony concentrations can vary from about 4 to 15% by weight of the tin in the tin oxide with 5 to 10% by weight preferred and 6 to 8% by weight most preferred. The thickness of the individual NIR sub-layer(s) that makes up the multi-layer stack can vary but a relatively equal thickness distribution is preferred. The total thickness of the NIR sub-layer(s) is in the range of 180 to 260 nm, preferable 190 to 240 nm and most preferable 200 to 230 nm.

The low refractive index (LI) sub-layer(s) has (have) a refractive index lower than the NIR sub-layer(s). The refractive index of the LI sub-layer(s) is preferably in the range of about 1.64 to 1.75, more preferably in the range of 1.66 to 1.73 and most preferably in the range of 1.67 to 1.71. The LI sub-layer(s) may contain inorganic compounds of silicon, aluminum, tin, phosphorous, boron and mixtures thereof. Preferred LI sub-layer(s) include silicon oxycarbide, silicon oxynitride and mixtures of silicon and tin oxide. A most preferred LI sub-layer is an amorphous mixture comprising silicon and tin oxides. The thickness of the LI sub-layer is in the range of about 30 to 100 nm with 40 to 90 nm being preferred and 50 to 80 nm being most preferred. The use of an amorphous sub-layer(s) provides superior haze control in comparison to a crystalline sub-layer.

The next layer is a low emissivity layer such as that taught in U.S. Pat. No. 6,218,018, incorporated herein by reference. The low emissivity layer is one having an emissivity of less than 0.4, and preferably an emissivity of less than 0.2. The low emissivity layer comprises a metal oxide such as tin oxide, indium oxide or zinc oxide that contains a low emissivity dopant such as fluorine or phosphorous that imparts significant conductivity to the layer. Fluorine or phosphorous are preferred although other dopants may be used in combination with the low emissivity dopant. In a preferred embodiment, the low emissivity layer is selected from fluorine-doped tin oxide, antimony-doped tin oxide, phosphorous-doped tin oxide, tin-doped indium oxide, and fluorine-doped zinc oxide. Fluorine-doped tin oxide is especially preferred.

The low-emissivity layer can be composed of a single layer, or may be a composite of several layers, such as for instance a fluorine-doped tin oxide layer and an antimony-doped tin oxide layer. The layers in any multi-layer low-emissivity layer can be stacked in any order

The low emissivity layer preferably has a thickness of between about 150 and 450 nm, and more preferably between about 250 and 350 nm.

Preferably, the low emissivity layer is deposited directly on the multi-layer stack.

In addition to the low emissivity layer and multi-stack layer, it is contemplated that the solar control glass composition may optionally contain one or more other layers. These optional layers may be present as undercoating layers, or they may be in other positions in the layered composition. Optional layers that may be present include, but are not limited to, an amorphous layer of a mixture of tin and silicon oxides, or silicon oxide.

In a preferred embodiment, no optional layers are present.

The transparent substrate of the invention may be any clear, structural substrate, upon which a coating can be placed. This includes, but is not limited to, glasses and structural plastics. In one preferred embodiment, the glass is a soda lime silica glass.

The coated transparent substrate of the invention has a neutral reflected color (when deposited on a colorless substrate), so that (a*²+b*²)^{1/2} is less than 12, preferably less than 8 and more preferably less than 5.

The coated article is produced by depositing the layers sequentially on a heated transparent substrate, by means known in the art such as spray pyrolysis or chemical vapor deposition (CVD), preferably atmospheric chemical vapor deposition methods. Spray pyrolysis is known and disclosed in patents such as U.S. Pat. No. 4,349,370 (Terneu). CVD methods for depositing SnO₂ films with or without dopants and the chemical precursors for forming SnO₂ films containing dopants are well known and disclosed in U.S. Pat. Nos. 3,331,702, 4,601,917, and 4,265,974. The preferred method is CVD of the doped SnO₂ layers according to known methods directly onto the float glass ribbon either immediately outside of or within the float bath chamber. CVD of doped tin oxide within the float bath chamber is taught by U.S. Pat. No. 4,853,257 (Henery). The process is very amenable to existing commercial on-line deposition systems.

Water is preferably used to accelerate the deposition of SnO₂ coatings onto glass as taught by U.S. Pat. No. 4,590,096 (Lindner) and used in concentrations from ˜0.75 to 12.0 mole % based on tin precursor concentrations and deposition rates required.

The coatings function by a combination of reflection and absorption. The low emissivity film reflects mid-IR heat in the 2.5 to 25 micron region of the spectrum while the NIR sub-layer absorbs heat primarily in the 750-2500 nm region. The low index sub-layer, in combination with the NIR sub-layer, provides anti-iridescence properties via destructive interference.

Precursors for the dopant (antimony, tungsten, vanadium, iron, chromium, molybdenum, niobium, cobalt and nickel) in the NIR sub-layer(s) are preferably metal halides such as antimony trichloride, however metal alkoxides, esters, acetylacetonates and carbonyls that are sufficiently volatile and reactive can be used as well. Other suitable precursors for the dopant and SnO₂ are well known to those skilled in the art. Dopant precursors which are solid, such as antimony trichloride, may be more easily used by first dissolving them into a liquid tin precursor to form a liquid solution. The resulting liquid solution can then be readily stored, pumped, metered by process flow control devices and vaporized.

Silicon oxide coatings can be produced from silane. The deposition of amorphous mixed tin and silicon oxide coatings from monobutyltintrichloride, a silica precursor such as tetraethylorthosilicate, and an accelerant such as triethylphosphite is taught in U.S. Pat. No. 5,401,305.

Suitable precursors and quantities for the fluorine dopant in the low emissivity layer are disclosed in U.S. Pat. No. 4,601,917 and include trifluoroacetic acid, ethyltrifluoroacetate, ammonium fluoride (spray pyrolysis only), and hydrofluoric acid. The molar ratio of fluorine precursor to tin precursor in the CVD vapor feed stream is typically between 0.05:1 and 0.30:1. This generally correlates to a fluorine concentration in the low emissivity film of from 1 to 5 weight percent.

The preferred multi-stack film can be deposited in a similar fashion as the low emissivity film using such methods as disclosed in U.S. Pat. No. 4,601,917. The organotin precursors for SnO₂ can be vaporized in air or other suitable carrier gases containing a source of O₂ and in precursor concentrations from 0.25-4.0 mole % (0.5-3.0 mole % more preferred). SnO₂ precursor concentrations are expressed herein as a percentage based upon the moles of precursor and the moles of CVD vapor. The preferred molar ratio of solar absorbing dopant precursor to tin precursor in the CVD vapor feed stream is typically between about 0.02:2 to about 0.35:1 (0.14:1 to 0.35:1 more preferred). Preferred is an antimony dopant using antimony trichloride as the precursor at about 4% to about 15% by weight in monobutyltintrichloride. This correlates to a similar antimony mass percent in the tin oxide film.

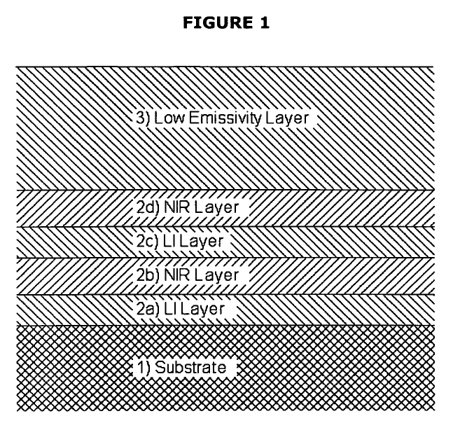

The coated glass of the present invention is depicted in FIG. 1 showing the film in cross section. The film thickness of the low emissivity film (3) can range from 150 to 450 nm.). The total thickness of the low emissivity layer(s) (LI) (2a and 2c) can range from 30-100 nm, while the total thickness of the NIR layers (2b and 2d) can range from 180-260 nm.

Another embodiment of this invention is the reduction of film haze. Haze is caused by the scattering of incident light by a rough surface or interface or inclusions or voids within the coating.

The preferred embodiments of our invention will be exemplified by the following examples. One skilled in the art will realize that minor variations outside the embodiments stated herein do not depart from the spirit and scope of this invention.

### EXAMPLES

The process can be conducted on a linear injector reactor, well know to one skilled in the art. Typically this type of reactor can be used in an open system at atmospheric pressure or in a controlled atmosphere region such as a float bath. High velocities are employed to achieve short residence times. Multi-port injection can be used to prevent mixing of highly reactive reactant gases until they are dispensed into the deposition zone. In addition, inert purge gas (typically nitrogen) can be dispensed before and after the injectors and exhausted through the deposition region exhaust. This ensures that the reactive gases are contained within the desired regions of the reactor and removed rapidly. Multiple reactors can be combined in a configuration that enables multiple layers to be deposited in a short time. In a 6-slot reactor configuration, vapor containing about 0.22 mole % monobutyltin trichloride (MBTC), 0.43 mole % tetraethoxysilane. 0.07 mole % triethylphosphite, 0.34 mole % water and the remaining air was fed to reactor slots 1,3 and 5 at a gas velocity of about 10 Sm³/m/hr. Simultaneously, a vapor containing about 1.01 mole % MBTC, 0.09 mole % antimony trichloride, 1.64 mole % water and the remaining air was fed to slots 2, 4 and 6 at the same velocity. A multi-layer film stack of about 310 nm was deposited on 6 mm soda-line-silica float glass at a temperature of about 650° C. in about 9.5 seconds. The stack was immediately overcoated with a vapor of about 1.34 mole % MBTC, 0.53 mole % trifluoroacetic acid, 1.34 mole % water and the rest air at a velocity of about 12 Sm³/m/hr to produce a low emissivity layer of about 320 nm. The resultant multi-layer film had a neutral-green front side reflected color, a bluish green backside color, a visible transmission of 60% and a haze 0f 1.9%. In a similar manner, the multi-layer stack was deposited with the underlayer vapor feed going to consecutive slots instead of alternating one. The resultant film had a haze of 5-6%.

While the present invention has been described with respect to particular embodiments thereof, it is apparent that numerous other forms and modifications of the invention will be obvious to those skilled in the art. The appended claims and this invention generally should be construed to cover all such obvious forms and modifications that are within the true spirit and scope of the present invention.

What is claimed is:

1. A coated solar control transparent substrate composition comprising the following layers:
a) a transparent substrate;
b) a multi-layer stack comprising at least three sub-layers, said sub-layers including at least one near infrared absorbing sub-layer having a relatively high refractive index, and at least one sub-layer having a relatively low refractive index; and
c) a low emissivity layer.

2. The coated solar control transparent substrate of claim 1, wherein said substrate is soda lime silica glass.

3. The coated solar control transparent substrate of claim 1, having a haze is less than about 2%.

4. The coated solar control transparent substrate of claim 1, wherein said low emissivity layer has an emissivity lower than about 0.4.

5. The coated solar control transparent substrate of claim 1, wherein said low emissivity layer comprises a doped metal oxide selected from the group consisting of tin doped with fluorine and/or phosphorous, zinc doped with fluorine and indium doped with tin.

6. The coated solar control transparent substrate of claim 1, wherein said low emissivity layer comprises a doped metal oxide selected from the group consisting of fluorine-doped tin oxide, antimony-doped tin oxide, phosphorous-doped tin oxide, tin-doped indium oxide and fluorine-doped zinc oxide.

7. The coated solar control transparent substrate of claim 1, wherein said low emissivity layer has a thickness of from 150 to 450 nanometers.

8. The coated solar control transparent substrate of claim 1, wherein said at least one near infrared absorbing sub-layer comprises an inorganic oxide of tin containing a dopant selected from the group consisting of antimony, tungsten, vanadium, iron, chromium, molybdenum, niobium, cobalt, nickel and mixtures thereof.

9. The coated solar control transparent substrate of claim 8, wherein said near infrared absorbing sub-layer comprises doped tin oxide.

10. The coated solar control transparent substrate of claim 1, wherein said at least one near infrared absorbing sub-layer has a refractive index of from 1.72 to 2.00.

11. The coated solar control transparent substrate of claim 1, wherein said at least one relatively low refractive index sub-layer comprises inorganic oxides of silicon, aluminum, tin, phosphorous, boron and mixtures thereof.

12. The coated solar control transparent substrate of claim 1, wherein said at least one relatively low refractive index sub-layer comprises a layer comprising silicon and tin oxides.

13. The coated solar control transparent substrate of claim 1, wherein said at least one relatively low refractive index sub-layer comprises a layer comprising silicon oxycarbide.

14. The coated solar control transparent substrate of claim 1, wherein said at least one relatively low refractive index sub-layer comprises a layer comprising silicon oxide.

15. The coated solar control transparent substrate of claim 1, wherein said multi-layer stack comprises from three to ten sub-layers.

16. The coated solar control transparent substrate of claim 1, wherein said sub-layers are amorphous.

17. The coated solar control transparent substrate of claim 1, wherein adjacent sub-layers alternate between a sub-layer having a relatively high refractive index, and a sub-layer having a relatively low refractive index.

18. The coated solar control transparent substrate of claim 1, wherein adjacent sub-layers comprise sub-layers having a relatively high refractive index or sub-layers having a relatively low refractive index.

19. A process for producing a coated solar control transparent substrate composition comprising sequentially depositing on a transparent substrate:
a) a multi-layer stack comprising at least three sub-layers, said sub-layers including at least one solar heat absorbing sub-layer having a relatively high refractive index, and at least one sub-layer having a relatively low refractive index; and
b) a low emissivity layer.

20. The process of claim 19, wherein said substrate is soda lime silica glass.

21. The process of claim 19, wherein said low emissivity layer has an emissivity lower than about 0.4.

22. The process of claim 19, wherein said coated solar control transparent substrate having a haze less than about 2%.

23. The process of claim 21, wherein said low emissivity layer comprises a doped metal oxide selected from the group consisting of tin doped with fluorine and/or phosphorous, zinc doped with fluorine and indium doped with tin.

24. The process of claim 19, wherein said low emissivity layer comprises a doped metal oxide selected from the group consisting of fluorine-doped tin oxide, antimony-doped tin oxide, phosphorous-doped tin oxide, tin-doped indium oxide and fluorine-doped zinc oxide.

25. The process of claim 19, wherein said low emissivity layer has a thickness of from 150 to 450 nanometers.

26. The process of claim 19, wherein said at least one near infrared absorbing sub-layer comprises an inorganic oxide of tin containing a dopant selected from the group consisting of antimony, tungsten, vanadium, iron, chromium, molybdenum, niobium, cobalt, nickel and mixtures thereof.

27. The process of claim 26, wherein said near infrared absorbing sub-layer comprises doped tin oxide.

28. The process of claim 19, wherein said at least one near infrared absorbing sub-layer has a refractive index of from 1.72 to 2.00.

29. The process of claim 19, wherein said at least one relatively low refractive index sub-layer comprises inorganic oxides of silicon, aluminum, tin, phosphorous, boron and mixtures thereof.

30. The process of claim 19, wherein said at least one relatively low refractive index sub-layer comprises a layer comprising silicon and tin oxides.

31. The process of claim 19, wherein said at least one relatively low refractive index sub-layer comprises a layer comprising silicon oxycarbide.

32. The process of claim 19, wherein said at least one relatively low refractive index sub-layer comprises a layer comprising silicon oxide.

33. The process of claim 19, wherein said multi-layer stack comprises from three to ten sub-layers.

34. The process of claim 19, wherein said sub-layers are amorphous.

35. The process of claim 19, wherein adjacent sub-layers alternate between a sub-layer having a relatively high refractive index, and a sub-layer having a relatively low refractive index.

36. The process of claim 19, wherein adjacent sub-layers comprise sub-layers having a relatively high refractive index or sub-layers having a relatively low refractive index.
